(19) United States
(12) Patent Application Publication
(10) Pub. No.: US 2020/0232434 A1
(43) Pub. Date: Jul. 23, 2020

(54) VALVE ASSEMBLY FOR AN INJECTION VALVE AND INJECTION VALVE

(71) Applicant: Vitesco Technologies GMBH, Hannover (DE)

(72) Inventors: Fabio Pacchini, Rosignano Solvay (IT); Matteo Soriani, Livorno (DE); Ivano Izzo, Pisa (IT)

(73) Assignee: Vitesco Technologies GMBH, Hannover (DE)

(21) Appl. No.: 16/840,508

(22) Filed: Apr. 6, 2020

Related U.S. Application Data
(63) Continuation of application No. PCT/EP2018/076408, filed on Sep. 28, 2018.

(30) Foreign Application Priority Data
Oct. 6, 2017 (EP) 17195142.9

(51) Int. Cl. F02M 61/10; F02M 61/16; F02M 63/00; B05B 1/30

(52) U.S. Cl. CPC F02M 61/10; B05B 1/3053; F02M 63/0077; F02M 61/165

(57) ABSTRACT

A valve assembly for an injection valve includes a valve body that includes a cavity with a fluid inlet portion and a fluid outlet portion. The cavity includes a first portion extending from the fluid inlet portion to a bottom surface and a second portion extending from a central opening in the bottom surface down towards the fluid outlet portion. The valve assembly includes a valve needle axially movable in the cavity. The valve needle includes a shaft and a ball; the ball cooperating with a valve seat to prevent a fluid flow through the fluid outlet portion in a closing position and to release the fluid flow through the fluid outlet portion in further positions. The valve assembly includes a seat body forming the valve seat and a ball guide. The valve assembly includes where a lower particle filter is entirely arranged in the second portion of the cavity.

### CROSS-REFERENCE TO RELATED APPLICATIONS

This application claims the benefit of International Application No. PCT/EP2018/076408, filed Sep. 28, 2018, which claims priority to European Application No. EP 17195142.9, filed Jun. 10, 2017. The disclosures of the above applications are incorporated herein by reference.

### TECHNICAL FIELD

The disclosure relates to a valve assembly for a fluid injection valve and to a fluid injection valve, e.g. a fuel injection valve of a vehicle. It particularly relates to solenoid injection valves.

### BACKGROUND

In order to keep contamination in the form of particles from entering an injection valve, a particle filter is usually arranged near a fluid inlet portion of the injection valve. However, this particle filter cannot prevent particles from internal contamination generated, for example, by component cleanliness, press-fitting operation and laser welding from entering the ceiling area of the valve. This creates a possible risk of injector stuck open.

An injection valve with a particle filter arranged directly above the valve seat surrounding the ball is known. This filter would be suitable to prevent particles from entering the sealing area. However, this injector includes a special component, the ball guide or the ball stop to guide the ball in its upward and downward movement. The particle filter is integrated in the ball guide or ball stop.

New injector designs, however, employ and integrated ball guide. The integrated ball guide is implemented by a seat body, which is an integral part of the valve body and forms the valve seat and a ball guide. The seat body, serving as a ball guide, surrounds the ball closely in order to perform its guiding function. Therefore, it is not possible to use a particle filter with an injection valve of the integrated ball guide design.

### SUMMARY

A valve assembly for an injection valve and an injection valve that overcome the above-mentioned difficulties and/or provide a stable performance of the injection valve by minimizing the risk of injector stuck open is provided.

One aspect of the disclosure provides a valve assembly for an injection valve. The valve assembly includes a valve body with a central longitudinal axis. The valve body includes a cavity with a fluid inlet portion and a fluid outlet portion. The cavity includes a first portion extending from the fluid inlet portion to a bottom surface and a second portion extending from a central opening in the bottom surface down towards the fluid outlet portion.

The valve assembly further includes a valve needle axially movable in the cavity, i.e. it is arranged in the cavity and axially displaceable relative to the valve body in reciprocating fashion. The valve needle includes a shaft and a ball. The ball cooperating with the valve seat to prevent fluid flow through the fluid outlet portion in the closing position and to release fluid flow through the fluid outlet portion in further positions. The ball may be fixed to the shaft, e.g. by a welded connection. The ball also may be formed by shaping a tip of the shaft.

The valve assembly further includes a seat body. The seat body is an integral part of the valve body and forms the valve seat and a ball guide. The valve assembly further includes an armature of an electromagnetic actuator unit designed to actuate the valve needle. The armature arranged in the first portion of the cavity.

A particle filter is entirely arranged in the second portion of the cavity. The particle filter is denoted as “lower particle filter” in the following due to its position adjacent to the fluid outlet portion. The valve assembly may additionally include an upper particle filter adjacent to the fluid inlet portion, for example upstream of the armature.

Implementations of the disclosure may include one or more of the following optional features. In some implementations, the lower particle filter is spaced from the bottom surface in axial direction towards the fluid outlet portion. In some examples, the lower particle filter is positioned upstream of the seat body. The entire lower particle filter may be positioned outside of the seat body. Expediently, the lower particle filter may be arranged adjacent to or adjoining the seat body. For example, the lower particle filter may bear on an upstream surface of the seat body in some implementations.

By the seat body being an integral part of the valve body it is understood that the seat body forms a part of the valve body. The seat body usually is not formed in one piece with the part of the valve body surrounding the needle shaft. Instead, the seat body is a separate part joined to the part of the valve body surrounding the needle shaft for example by press-fitting. In the region of the valve seat, this seat body constitutes the valve body and therefore forms an integral part of the valve body.

This valve assembly has the advantage that the injector reliability is improved by introducing an obstacle to contamination coming from external or internal sources that could cause the injector stuck open issue or jeopardize the sealing area increasing the leakage rate or occlude the seat holes totally or partially. Furthermore, the integrated ball guide provides a very stable and reliable guidance to the ball resulting in a valve assembly which can operate reliably and precisely even under high pressure conditions. With advantage, the ball guide is not provided by the lower particle filter which is comparably easily deformable, but by direct contact between the ball and the rigid seat body which can easily be manufactured with small tolerances.

In some implementations, at least one element of the lower particle filter is fixed to the valve needle.

Basically, with the integrated ball guide design of the injector, the lower particle filter can either be fixed to the valve needle, or to the valve body, or to both. The lower particle filter can consist of only one element, but it can also include several collaborating elements.

In some implementations, the lower particle filter is comprised of one element—for example, it consists of one element—which is fixed to the needle, where a clearance is formed between an outer rim of the lower particle filter and the valve body. In this case, the clearance may represent an annular gap between the lower particle filter and the valve body extending completely around the lower particle filter in circumferential direction. According to this implementation, the clearance is calculated in order to avoid the contact between the lower particle filter and the valve body without affecting the filtering efficiency. It is an advantage of this implementation that no mechanical interaction takes place between the lower particle filter and the valve body, which helps reduce wear of components.

In some examples, the lower particle filter is comprised of one element—i.e. in particular consists of one element—which is fixed to the needle, wherein one section of the lower particle filter is resiliently supported by the valve body. According to this example, there is no clearance or gap between the lower particle filter and the valve body. Instead, the lower particle filter being resiliently supported by the valve body causes a close mechanical contact between the lower particle filter and the valve body. Because of the resilient force, the lower particle filter does not part from the valve body due to movement of the needle. The movement of the needle will take at least one section of the lower particle filter with it, while another section of the lower particle filter being resiliently supported by the valve body remains in contact with the valve body. In order to achieve this, the lower particle filter might be bent, for example bellow-shaped and preloaded during assembly. This example has the advantage, that the lower particle filter covers the entire fuel passage.

In some implementations, the lower particle filter includes at least two elements, a first element being fixed to the valve needle and the second element being fixed to the valve body. In one development, the lower particle filter consists of the first element and the second element.

In this case, the first element and the second element may remain in contact with each other during opening and closing of the valve. To achieve this, the first element may be resiliently supported by the second element. This implementation has the advantage, that the lower particle filter covers the entire fuel passage.

Alternatively, a clearance can be formed between the first element and the second element so that there is no mechanical interaction between the two elements. The clearance between the first element and the second element is calculated in order to avoid the contact between the two elements without affecting the filtering efficiency.

Another aspect of the disclosure provides a fluid injection valve with the described valve assembly. The injection valve may be a fuel injection valve of a vehicle.

The injection valve has the advantage, that injector stuck open events and leakages due to contamination in the region of the sealing zone can be prevented. The injection valve operates particularly stable and reliably.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows a cross-section of an injection valve with an integrated ball guide;

FIG. 2 shows a cross-section through the lower part of an injection valve according to a first example;

FIG. 3 shows a cross-section through the lower part of an injection valve according to a second example;

FIG. 4 shows a cross-section through the lower part of an injection valve according to a third example; and

FIG. 5 shows a cross-section through the lower part of an injection valve according to a fourth example.

Like reference symbols in the various drawings indicate like elements.

### DETAILED DESCRIPTION

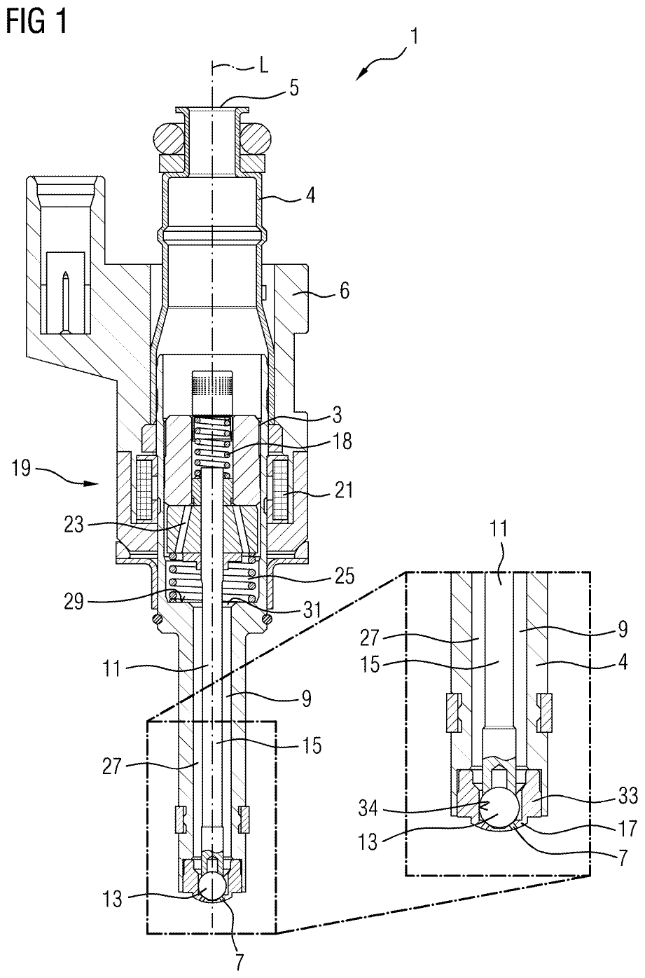

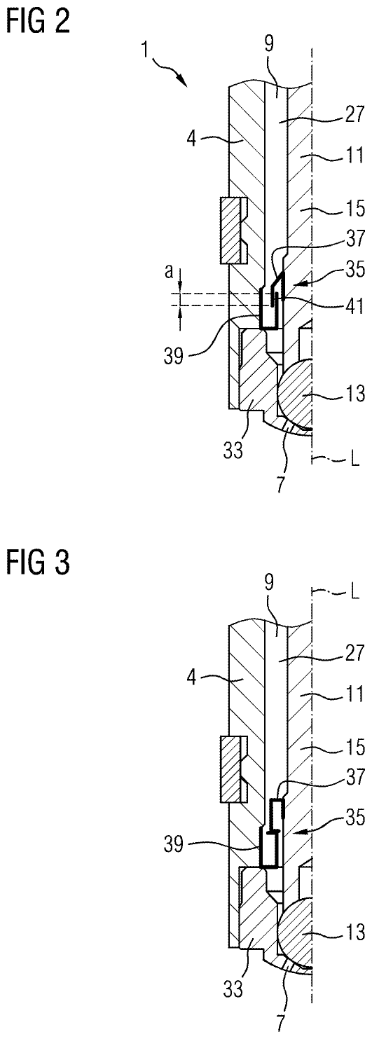

The fluid injection valve 1 shown in FIGS. 1 and 2 is in particular suitable for dosing fuel to a combustion engine. However, the valve 1 could be used in other types of injection valves, too.

The injection valve 1 includes a valve assembly 3. The valve assembly 3 includes a valve body 4 with a central longitudinal axis L. A housing 6 is partially arranged around the valve body 4.

The valve body 4 includes a cavity 9. The cavity 9 has a fluid outlet portion 7. The fluid outlet portion 7 communicates with a fluid inlet portion 5 which is provided in the valve body 4. The fluid inlet portion 5 and the fluid outlet portion 7 are in particular positioned at opposite axial ends of the valve body 4. The cavity 9 takes in a valve needle 11. The valve needle 11 includes a needle shaft 15 and a sealing ball 13 welded to the tip of the needle shaft 15.

In a closing position of the valve needle 11, it sealingly rests on a valve seat 17 having at least one injection nozzle constituting the fluid outlet portion 7. A preloaded calibration spring 18 exerts a force on the needle 11 towards the closing position. In the closing position of the valve needle 11, a fluid flow through the at least one injection nozzle is prevented. The injection nozzle may be, for example, an injection hole. However, it may also be of some other type suitable for dosing fluid.

The valve assembly 3 is provided with an electro-magnetic actuator unit 19. The electro-magnetic actuator unit 19 includes a solenoid 21, which is arranged inside the housing 6. Furthermore, the electro-magnetic actuator unit 19 includes an armature 23. The housing 6, parts of the valve body 4 and the armature 23 form an electromagnetic circuit. The armature 23 is axially movable in the cavity 9 and fixed to the valve needle 11 by form fit.

The cavity 9 includes a first portion 25 and a second portion 27. The first portion 25 extends from the fluid inlet portion 5 down towards a bottom surface 29 below the armature 23. The second portion 27 extends from a central opening 31, which accommodates the needle shaft 15, in the bottom surface 29 down towards the fluid outlet portion 7.

As can be seen from the detailed drawing on the right-hand side of FIG. 1, the valve assembly 3 has an integrated ball guide. It includes a seat body 33 which forms the valve body 4 in the region of the fluid outlet portion 7. The seat body 33 forms a valve seat 17 and it guides the ball 13 in an upward and downward movement. To achieve the guiding function, the seat body 33 has guiding surfaces 34. The guiding surfaces 34 alternate in circumferential direction with fluid channels through which fluid may pass the ball 13 in axial direction towards the valve seat 17. One such fluid channel is shown on the right side of the ball 13 in the detail drawing on the right-hand side of FIG. 1.

FIG. 2 shows a lower part of an injection valve 1 which corresponds to the injection valve 1 shown in FIG. 1 except that a lower particle filter 35 is added in the second portion 27 of the cavity 9.

According to the first example shown in FIG. 2, the lower particle filter 35 includes—and, in some examples, consists of—a first element 37, which is press fitted to the valve needle 11, and a second element 39 which is press fitted to the valve body 4 and bears on an upstream surface of the seat body 33. Between the first element 37 and the second element 39 there is a clearance 41. Along the clearance 41 the first element 37 and the second element 39 overlap in axial direction. Both elements 37, 39 are spaced apart from the bottom surface 29 in downstream axial direction.

When the needle 11 travels upwards to open the injection valve 1, the overlap between the first element 37 and the second element 39 decreases during the travel of the needle 11, the clearance 41 between the first element 37 and the second element 39 remains. An overlap between the first element 37 and the second element 39 remains even when the needle 11 has traveled to its maximum. Thus, the maximum overlap a is larger than the maximum travel of the needle 11.

According to this first example, there is no mechanical interaction between the first element 37 and the second element 39 of the lower particle filter 35. This has the advantage, that problems due to wear of components are avoided.

The lower particle filter 35 according to all examples shown in the drawings and other examples of the disclosure may include or consist of one or more turned or stamped elements with holes, the holes being mechanically drilled or laser drilled. The element(s) may also be a braided net.

FIG. 3 shows a second example of the present disclosure. According to this example, the lower particle filter 35 includes—and preferably consists of—a first element 37 and a second element 39. However, according to the second example, there is no clearance between the two elements 37, 39. Instead, the first element 37, which is press fitted on the needle 11, is resiliently supported by the second element 39 which is press fitted in the valve body 4 and rests on the upstream surface of the seat body 33. Due to the shape of the two elements 37, 39 and the resilient force between them, they remain in contact during the travel of the needle 11.

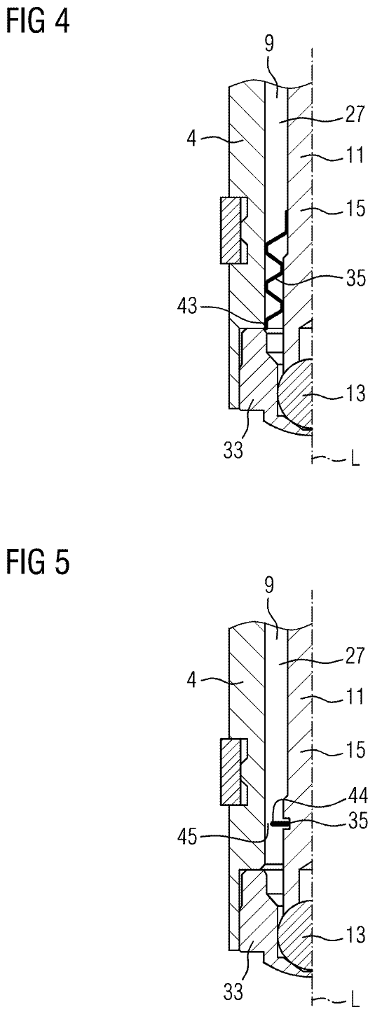

FIG. 4 shows a third example of the present disclosure. According to this example, the lower particle filter 35 includes only one element which is bellow-shaped and press-fitted to the needle 11. During assembly of the injection valve 1, the lower particle filter 35 is preloaded and one section 43 of the lower particle filter 35 resiliently rests against a section—for example, the upstream surface—of the seat body 33. The section 43 remains in contact with the seat body 33 during travel of the needle 11.

FIG. 5 shows a fourth example of the present disclosure. According to this example, the lower particle filter 35 includes only one element which is disc-shaped and press-fitted to the needle 11. Between the outer rim 44 of the lower particle filter 35 and the valve body 4, there is a clearance 45. The clearance 45 remains essentially constant during travel of the needle 11. Thus, there is no mechanical interaction between the lower particle filter 35 and the valve body, so that wear of components is reduced.

A number of implementations have been described. Nevertheless, it will be understood that various modifications may be made without departing from the spirit and scope of the disclosure. Accordingly, other implementations are within the scope of the following claims.

What is claimed is:

1. A valve assembly for an injection valve, the valve assembly comprising:
a valve body with a central longitudinal axis, the valve body comprising a cavity with a fluid inlet portion and a fluid outlet portion, the cavity comprises a first portion extending from the fluid inlet portion to a bottom surface and a second portion extending from a central opening in the bottom surface down towards the fluid outlet portion;
a valve needle axially movable in the cavity, the valve needle comprising a shaft and a ball, the ball cooperating with a valve seat to prevent a fluid flow through the fluid outlet portion in a closing position and to release the fluid flow through the fluid outlet portion in further positions;
a seat body being an integral part of the valve body and forming the valve seat and a ball guide;
an armature of an electro-magnetic actuator unit designed to actuate the valve needle, the armature arranged in the first portion of the cavity;
wherein a lower particle filter is entirely arranged in the second portion of the cavity.

2. The valve assembly according to claim 1, wherein the lower particle filter is spaced from the bottom surface in axial direction towards the fluid outlet portion.

3. The valve assembly according to claim 1, wherein the lower particle filter is positioned upstream of the seat body.

4. The valve assembly according to claim 1, wherein at least one element of the lower particle filter is fixed to the valve needle.

5. The valve assembly according to claim 4, wherein the lower particle filter includes one element fixed to the needle, wherein a clearance is formed between an outer rim of the lower particle filter and the valve body.

6. The valve assembly according to claim 4, wherein the lower particle filter includes one element fixed to the needle, wherein one section of the lower particle filter is resiliently supported by the valve body.

7. The valve assembly according to claim 4, wherein the lower particle filter includes at least two elements, a first element being fixed to the valve needle and a second element being fixed to the valve body.

8. The valve assembly according to claim 7, wherein the first element and the second element remain in contact with each other during opening and closing of the valve.

9. The valve assembly according to claim 7, wherein a clearance is formed between the first element and the second element.

10. A fluid injection valve with a valve assembly, the valve assembly comprising:
a valve body with a central longitudinal axis, the valve body comprising a cavity with a fluid inlet portion and a fluid outlet portion, the cavity comprises a first portion extending from the fluid inlet portion to a bottom surface and a second portion extending from a central opening in the bottom surface down towards the fluid outlet portion;
a valve needle axially movable in the cavity, the valve needle comprising a shaft and a ball, the ball cooperating with a valve seat to prevent a fluid flow through the fluid outlet portion in a closing position and to release the fluid flow through the fluid outlet portion in further positions;
a seat body being an integral part of the valve body and forming the valve seat and a ball guide;
an armature of an electro-magnetic actuator unit designed to actuate the valve needle, the armature arranged in the first portion of the cavity;
wherein a lower particle filter is entirely arranged in the second portion of the cavity.
